(19) United States
(12) Patent Application Publication
(10) Pub. No.: US 2022/0394961 A1
(43) Pub. Date: Dec. 15, 2022

(54) INTEGRATED HOOK HARNESS AND FISHING LURES INCORPORATING THE SAME

(71) Applicant: Mystery Tackle Box, Inc., Chicago, IL (US)

(72) Inventors: Jacob Alan MORGAN, Chicago, IL (US); Gabriel PRERO, Chicago, IL (US); Christopher John BULAW, Roselle, IL (US); Matthew Roy KESTUFSKIE, Chicago, IL (US)

(73) Assignee: Mystery Tackle Box, Inc., Chicago, IL (US)

(21) Appl. No.: 17/344,214

(22) Filed: Jun. 10, 2021

(51) Int. Cl. A01K 85/02; A01K 85/18

(52) U.S. Cl. CPC A01K 85/02; A01K 85/18

(57) ABSTRACT

An improved fishing lure is disclosed that includes an integrated hook harness to which one or more hooks may be movably secured. The hooks are maintained in a neutral state by a retention mechanism provided in the harness that may be released when a fish strikes the lures, allowing the hook to move freely relative to the hook harness and lure body. Because the hook is able to move relative to the hook harness and lure body, the weight of the hook harness and lure body do not act directly on the hook and the likelihood of the fish kicking free is substantially decreased.

### BACKGROUND OF THE INVENTION

### Field of the Invention

The present disclosure is generally directed toward artificial fishing lures and more particularly to an improved fishing lure including an integrated hook harness that permits movement of an attached fishing hook relative to the lure body.

### Background

Fishing is one of the most popular outdoor recreational activities in the world, with an estimated 50 million Americans engaged in freshwater, saltwater, and fly-fishing activities annually. Fishing often involves using a bait, which may be natural or artificial, that is attached or otherwise coupled with one or more hooks and tied to a line that may be cast (e.g., using a rod and reel) out over a body of water (e.g., a lake, stream, or ocean) to attract a fish and elicit a strike. Once the fish strikes, the hook(s) coupled to the bait pierce into the tissue of the fish, typically in the fish's mouth, resulting in a hookset which allows the fish to be caught once the line is drawn in. The type of bait that is used will typically vary depending on the species of fish and the habitat or conditions in which it is being fished.

A fishing lure is a type of artificial fishing bait which is designed to attract or “lure” a fish to strike (e.g., using movement, vibration, flash and/or color to bait the fish). Fishing lures generally seek to emulate the appearance and/or movement of prey, but may also appeal to a fish's sense of territory, curiosity and/or aggression. Fishing lures, for example, may be designed to look like smaller prey, or may be engineered to “swim” through the water as the line is drawn in.

Fishing lures can be made of a variety of different materials and can take on a variety of different forms. Soft bodied fishing lures (e.g., made of plastic or rubber) are a popular type of lure, and commonly take the shape of smaller prey or other creatures. A user may “rig” the lure by inserting a hook into the body of the plastic, or the lure may be “pre-rigged,” with the hook already formed within the plastic body. Some soft bodied lures may be provided with fins or other appendages that may guard or shield the exposed portion of the hook, allowing the lure to be used in conditions where there may be aquatic vegetation, or “weeds,” on which the hook would otherwise get caught. When a fish strikes at these “weedless” lures, the appendages may be displaced exposing the hook point and allowing for a hook set.

One problem with conventional soft bodied lures stems from the fact that the hook is fixed in place to the lure body, such that a significant amount of mass is attached to the hook, particularly where the lure is weighted. When a fish is initially hooked, it will frequently kick and thrash, which may dislodge the hook; the more mass that is fixed to the hook the greater the forces acting on the hook as the fish attempts to get free, and the more likely it is that the hook will become disengaged.

### BRIEF SUMMARY OF THE INVENTION

The present invention seeks to address the above-mentioned problems with conventional soft bodied lures by making use of an integrated hook harness to which one or more hooks may be movably secured, for example, by means of a pivot, hinge or other suitable joint. The hook(s) may be maintained in a neutral state by a hook retention mechanism, and may be released from the retention mechanism when a fish strikes the lure (i.e., upon application of a minimum actuation force), allowing the hook to move freely relative to the hook harness and lure body. In some embodiments, for example, the retention mechanism may take the form of a magnet secured to the hook harness. In other embodiments, the hook may be snap-fit or press fit to the hook harness (e.g., using a cuff or sleeve, a structured wall, or other suitable design).

Because the hook is able to move relative to the hook harness and lure body, the weight of the hook harness and lure body do not act directly on the hook and the likelihood of the fish kicking free is substantially decreased. Moreover, by integrating the retention mechanism within the hook harness a consistent mechanical interfacing between the hook and retention mechanism can be ensured. For example, a magnet formed within the lure body could easily become dislodged or misaligned through use, but by integrating the magnet within the hook harness such issues can be mitigated or eliminated altogether. Furthermore, because the retention mechanism is provided within the hook harness itself, the hook harness need not be integrally formed within the lure body and can be used with non-preformed lures (i.e., where the user “rigs” the lure themselves). The integrated hook harness is also particularly well suited for use in weedless fishing lures since the hook(s) can be disposed entirely within the lure body when in a neutral state, eliminating the need for additional fins or appendages to guard the hook.

### BRIEF DESCRIPTION OF THE DRAWINGS

The accompanying drawings, which are incorporated herein and form part of the specification, illustrate one or more aspects of the present invention and, together with the description, further serve to explain the principles of the invention and to enable a person skilled in the relevant art(s) to make and use the invention.

FIG. 1 depicts a first exemplary embodiment of a fishing lure including a integrated hook harness according to the present invention.

FIG. 2 illustrates a perspective view of the integrated hook harness of the first exemplary embodiment.

FIG. 3 depicts a second exemplary embodiment of a fishing lure including a integrated hook harness according to the present invention.

FIG. 4 depicts a third exemplary embodiment of a fishing lure including a integrated hook harness according to the present invention.

FIG. 5 depicts a fourth exemplary embodiment of a fishing lure including a integrated hook harness according to the present invention.

The features and advantages of the disclosed embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. Unless otherwise indicated, the drawings provided throughout the disclosure should not necessarily be interpreted as to-scale drawings.

### DETAILED DESCRIPTION

This specification discloses one or more embodiments that incorporate the features of this invention. The disclosed embodiment(s) merely exemplify the invention, and the scope of the invention is not thus limited. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

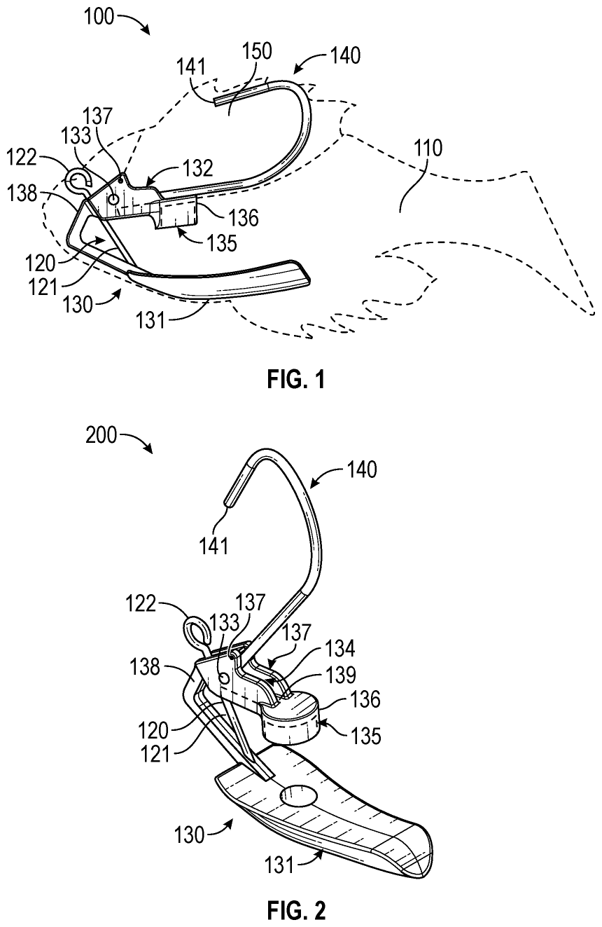

FIG. 1 depicts an exemplary embodiment of a fishing lure 100 having a integrated hook harness configured to movably secure a hook within the fishing lure. FIG. 2 depicts a perspective view of the integrated hook harness. As illustrated, the fishing lure 100 may include a lure body 110, line the 120, integrated hook harness 130, and hook 140. The fishing lure 100 may be a soft bodied lure having a lure body 110 formed of soft plastic or rubber, which may take on any number of shapes and sizes. The lure body 110, for example, may take the form of prey fish (e.g., rainbow smelt, gizzard shad, perch, blue gill, etc.) or other creatures (e.g., crabs, squid, worms, lizards, frogs, leeches, etc.) and objects suitable to attract a target fish. As illustrated in FIG. 1, the lure body 110 is shaped like a Bluegill, a common bait used for fishing Bass.

The line the 120 of the fishing lure 100 may generally allow for the fishing lure 100 to be secured to a fishing line (not illustrated). The line the 120 may be made of a light-weight plastic or metal and may consist of a tie body 121 and an eye 122 to which the fishing line may be secured (e.g., using a knot). The tie body 121 may be used to secure the line tie 120 within the lure body 110 (e.g., via the integrated hook harness 130) and may operate to translate the forces applied by the fishing line to the integrated hook harness 130 and lure body 110. The eye 122 may be positioned at an end of the tie body 121 and may extend beyond the lure body 110 to permit securement of the fishing line thereto. As illustrated in FIG. 1, the line tie 120 is wire-like in form having adequate thickness to maintain rigidity and sufficient length to be secured within the lure body 110 (i.e., between a first and second end of the connecting arm 138 of the integrated hook harness 130). The ends of the tie body 121 may be threaded or textured (or include similar features) that allow for firm securement within the integrated hook harness 130. The eye 122 may be a closed eye or an open eye, and may only be partially exposed beyond the lure body 110 such that accessing the eye 122, or an opening provided thereon, may require compressing or otherwise manipulating the lure body 110 to more fully expose the eye 122. The line tie 120 may be oriented within the lure body 110 (and integrated hook harness 130) such that the neutral orientation of the fishing lure 100 will generally be maintained upon retrieval of the fishing line. In this way, the fishing lure 100 may better emulate the natural movement of prey as the lure is retrieved, and more effectively attract the sought after fish.

The integrated hook harness 130 of fishing lure 100 may act to orient and secure the line tie 120 and hook 140 within lure body 110, with the hook 140 being secured to the hook harness 130 in a manner that permits movement of the hook 140 relative to the integrated hook harness 130 and lure body 110. By allowing the hook 140 to move relative to the integrated hook harness 130 and lure body 110, the weight of the integrated hook harness 130 and lure body 110, and any forces applied to those elements, do not act directly on the hook 140, decreasing the likelihood that a fish will be able to kick free. The integrated hook harness 130 may also be designed to provide additional weight to the fishing lure 100 so as to affect the manner in which the fishing lure 100 may swim in the water and/or the flight of the fishing lure 100 through the air when being cast. And because the hook 140 is movably secured to the integrated hook harness 130, any detrimental effects of this additional weight are minimized, allowing the fishing lure 100 to be more heavily weighted without compromising the effectiveness of the fishing lure 100.

As illustrated in FIG. 1, the integrated hook harness 130 may include a weighted portion 131 and a hook securement portion 132 joined together by connecting arm 138. The weighted portion 131, hook securement portion 132, and connecting arm 138 may be integrally formed together, for example, being cast out of one or more plastics and/or metals, or may be discrete elements that can be assembled or mechanically connected together to form the integrated hook harness 130. This integrated design can facilitate easier production, particularly in the case of pre-formed lures, as only a single fixture must be secured when forming the lure body.

The weighted portion 131 may provide additional weight to the fishing lure 100, with the amount of weight provided by the weighted portion 131 depending on the sink rate and/or fishing depth desired for the fishing lure 100. The shape and position of the weighted portion 131 may allow the weight of the integrated hook harness 130 to be distributed within the lure body 110 in a particular manner. For example, as illustrated in FIG. 1, the weighted portion 131 may be generally disposed toward the bottom of lure body 110 and may be shaped so as to conform to the profile of the lure body 110 (e.g., along both its length and width). In this way, the weighted portion 130 may help to prevent the fishing lure 100 from “rolling over” in the water as the fishing lure 100 is being drawn in.

Furthermore, while a single weighted portion 131 is illustrated, alternative embodiments may include multiple weighted portions allowing the weight to be optimally distributed throughout the lure body 110 as desired. Some embodiments, for example, may provide an additional weighted portion toward the tail of the lure body 110, which may improve castability of the fishing lure 100 or affect desired swim dynamics. Other embodiments may forego a weighted portion altogether.

It should also be recognized that the material of the weighted portion 131 may be different (e.g., having increased density) from the remaining portions of the integrated hook harness 130, again, allowing the weight of the integrated hook harness 130 to be optimally distributed within the lure body 110. The weighted portion 131, for example, may be formed of a relatively dense metal (e.g., zinc, lead, or tungsten) while the rest of the integrated hook harness 130 may be formed of a light weight plastic (e.g., polypropylene or the like).

The hook securement portion 132 may include one or more elements that allow the hook 140 to be secured to the integrated hook harness 130 while also permitting the hook 140 to move relative to the integrated hook harness 130 and lure body 110. The range of motion of the hook 140 may depend on the coupling mechanism 142 that is used and the manner in which it mates or interfaces with the hook securement portion 132, for example, permitting one, two, or three degrees of rotational freedom.

By way of example, as illustrated in FIG. 1, the hook securement portion 132 includes a hook axle 133 that extends between the walls of a channel 134 extending up from the lower surface 139 of the hook securement portion 132. The hook 140, in turn, may be provided with a coupling mechanism at its proximal end (e.g., an eye, or sleeve, or similar feature) (not illustrated) such that it may be mechanically coupled to the hook axle 133, allowing the hook 140 to rotate or pivot about the hook axle 133. The hook securement portion 132 may also serve to limit the movement of the hook 140 so as to prevent damage to the lure body 110 in use. The hook 140, for example, may rest on the lower surface 139 (i.e., in a neutral position), and a hook stopper 137 may be provided across an upper region 134a of the channel 134, so as to limit rotation of the hook 140 beyond the hook stopper 137 (i.e., through a final position).

While the embodiment of FIG. 1 may rely on a hook axle 133 and hook stopper 137 to allow for and limit rotation of the hook 140, it should be recognized that other suitable securement mechanisms may be used instead (e.g., a hinge, ball and socket, or other suitable joint) so long as they permit movement of the hook 140 relative to the integrated hook harness 130 and lure body 110. For example, in alternative embodiments, the hook securement portion 132 may be provided with an eyelet (e.g., on lower surface 139) to which hook 140 may be secured (e.g., via an eyelet provided at its proximal end). Interlocking eyelets may generally permit a broader range of motion for the hook 140 (e.g., allowing for three degrees of rotational freedom), which may further attenuate the impact of forces experienced by the hook 140 and further decrease the likelihood that a fish will be able to kick free. The movement of hook 140, nevertheless, may be limited by the design of the hook securement portion 132 and the coupling mechanism of the hook 140 so as to prevent damage to the lure body 110. The pitch of hook 140, for example, may be limited by a lower surface 139 and hook stopper 137, the roll may be limited by the width of channel 134, and/or the yaw may be limited based on the geometry and thickness of the eyelets themselves.

The hook securement portion 132 may also include a retention mechanism that may operate to keep the hook 140 fixed in a neutral position. The retention mechanism, for example, may take the form of a magnet 135, which may be provided within an annular slot 136a formed in a region 136 of the hook securement portion 132 extending beyond the channel 134 along the length of the fishing lure 100, that may keep the hook 140 fixed in a neutral position at the base of the channel 134 along the lower surface 139. When a fish strikes at the fishing lure 100 an actuation force is applied to the hook 140 (i.e., sufficient to overcome the strength of the magnet 135), and the hook 140 may be released. Magnet 135 is not at risk of being ripped free or otherwise separated from the lure body 110 during use on account of its integration within the hook securement portion 132 of the integrated hook harness 130, which is itself anchored firmly within the lure body 110 (e.g., via connecting arm 138 and weighted portion 131). To the extent that the hook 140 is released but a hookset is not established, the hook 140 may return to its neutral position where it may again be secured by the retention mechanism (e.g., magnet 135). The hook 140 may return to the neutral position naturally (e.g., on account of gravity and/or the drag forces that the hook 140 may experience as the lure 100 is drawn in) or with the assistance of the user of the lure.

In alternative embodiments, the retention mechanism may allow the hook 140 to be snap-fit or press fit in place. The hook securement portion 132, for example, may be provided with a cuff or sleeve (e.g., on lower surface 139 in the region 136) into which the 140 could be snap-fit. Or, as another example, the walls of channel 134 may be provided with one or more features (e.g., bumps, ridges, or the like), which may act to secure the hook 140. In yet other instances, the width of channel 134 could be tolerance so as to form a press fit with the hook 140. The retention mechanism used (and its particular design) may dictate the amount of force required to release the hook 140, and may be adjusted based on the type of fish being sought or the conditions in which the lure will be used (e.g., allowing the hook 140 to release more or less easily as desired).

In order to accommodate movement of the hook 140, the lure body 110 may be provided with a hook slot 150 such that the hook 140 may be able to move freely (e.g., rotate about the hook axle 133) without experiencing resistance from the lure body 110 itself (i.e., due to friction between the hook 140 and lure body 110). The hook slot 150 may have a width slightly larger than the maximum thickness of hook 140, or the external width of channel 134, and may extend along the length of the fishing lure 100 such that the entire range of motion of the hook 140 may be accommodated (e.g., from its neutral position when secured by magnet 135 through the final position permitted by hook stopper 137). Furthermore, while fishing lure 100 is illustrated as having a 5/0 bait hook-styled fishing hook 140, alternative hook types (e.g., a circle hook, octopus hook, Aberdeen hook, Kahle hook, or the like) and sizes may be readily accommodated.

The connecting arm 138 may secure line tie 120 (as described above) and may join the weighted portion 131 and hook securement portion 132 together, allowing each to be positioned independently within lure body 110. The weighted portion 131, for example, may be disposed toward the bottom of the lure body 110, which as noted above may help prevent “rollover” or affect other swim dynamics, while the hook securement portion 132 may be positioned toward the center of the lure body 110 such that the hook point 141 of hook 140 sits at the edge of lure body 110. By increasing the distance between the weighted portion 131 and hook 140, the impact that the weight of the fishing lure 100 may have when a fish attempts to kick free is further minimized improving the chances of establishing a secure hook set. Furthermore, as noted above, despite being open to the hook slot 150, magnet 135 is not at risk of being ripped free or otherwise separated from the lure body 110 on account of its attachment to the integrated hook harness 130, which is anchored firmly within the lure body 110 (e.g., via the connecting arm 138 and weighted portion 131).

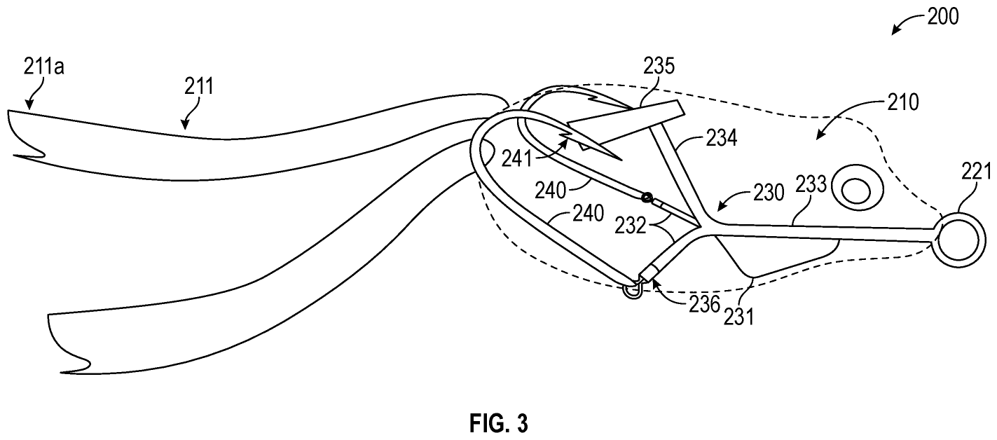

FIG. 3 depicts a second exemplary embodiment of a fishing lure 200 having an integrated hook harness configured to secure multiple fishing hooks. As illustrated, the fishing lure 200 may include a lure body 210, a magnet hook harness 230, and hooks 240. Fishing lure 200 may be a soft bodied lure, which as illustrated, emulates the form of a toad, another common bait used for fishing Bass. The fishing lure 200 may include a lure body 210 and legs 211, which may have paddles 211a provided at their tips that may serve to generate added movement in the water when the fishing lure 200 is being fished.

The integrated hook harness 230 may act to orient and secure a pair of hooks 240, with the hooks 240 being secured to the hook harness 230 in a manner that permits movement of the hooks 240 relative to the integrated hook harness 230 and lure body 210. As with the embodiment of FIG. 1, the weight of the lure body 210 and integrated hook harness 230, and any forces applied thereto, may not act directly on the hooks 140, improving the chances that a fish will be caught and unable to kick free.

As illustrated in FIG. 3, the integrated hook harness 230 may include a stem 233 having three branches, two hook securement branches 232 and a magnet securement branch 234, as well as a weighted portion 231. Similar to the embodiment of FIG. 1, the stem 233, hook securement branches 232, magnet securement branch 234, and weighted portion may be integrally formed together or may consist of discrete elements that are coupled together to form the integrated hook harness 230.

The stem 233 may function as a line tie, with an eye 221 attached at its proximal end (i.e., toward the mouth of the lure body 210), and may act to position the two hook securement branches 232 and magnet securement branch 234 within the lure body 210. The eye 221 may extend beyond the lure body 210 and may be used to secure a fishing line. The eye 221 is illustrated as a closed eye, but in alternative embodiments may be an open eye and may only be partially exposed beyond the lure body 210 such that accessing the eye 221, or an opening provided thereon, may require compressing or otherwise manipulating the lure body 210 to more fully expose the eye 221. The stem 233 may extend from the mouth of the lure body 210 along its length (i.e., in the direction of the legs 211) and terminate near the center of the lure body 210, and may act to position the hook securement branches 232 and magnet securement branch 234 as well as the weight portion 231.

As with the embodiment of FIG. 1, the weighted portion 231 of the integrated hook harness 230 may act to provide additional weight to the fishing lure 200 so as to affect the swim and/or castability of the fishing lure 200. The weighted portion 231, for example, is similarly disposed toward the bottom of lure body 210 and shaped to conform to the profile of the lure body 210 so as to help prevent the fishing lure 200 from rolling over as it is being fished.

The hook securement branches 232 and magnet securement branch 234 may act to secure a pair of hooks 240 and a magnet 235, respectively. More particularly, the hook securement branches 232 may extend outward (e.g., along the length, height, and width of the lure body 210), in a symmetric fashion, toward a lower outer surface of the lure body 210, and may include one or more elements that allow hooks 240 to be secured to the integrated hook harness 230 while also permitting the hook 240 to move relative to the integrated hook harness 230 and lure body 210. As illustrated in FIG. 3, for example, a pair of swivels 236 are provided at the end of the hook securement branches 232 which may extend beyond the lure body 210, such that the hooks 240 when secured to the swivels 236 are positioned outside the lure body 210. The hooks 240, in turn, may be provided with a coupling mechanism 242 (e.g., a slot, eye, or the like), such that they may be mechanically coupled to the swivels 236, allowing the hooks 240 to rotate or pivot about the swivels 236. The range of motion of the hooks 240 may depend on the coupling mechanism 242 that is used and the manner in which it mates or interfaces with swivels 236, for example, permitting one, two, or three degrees of rotational freedom.

The magnet securement branch 234, in turn, may extend outward (e.g., along a length and height of the lure body 210) toward an upper outer surface of the lure body 210 and may include one or more elements that may secure magnet 235, which may operate to keep hooks 240 fixed in a neutral position. As illustrated in FIG. 3, for example, the magnet securement branch 234 may terminate just short of the outer surface of the lure body 210 and may have a magnet 235 integrally formed at its terminal end, with the magnet 235 being positioned in a slot just below the surface of lure body 210. In alternative embodiments, the magnet securement branch 234 may extend just beyond the outer surface of the lure body 210, and magnet 235 may be positioned outside lure body 210. The hook points 241 of the hooks 240 may attach to magnet 235 to keep the hooks 240 in a closed, neutral position. When a fish strikes at the fishing lure 200, the hooks 240 may be released and free to rotate or pivot about swivels 236.

While the embodiment illustrated in FIG. 3 may make use of a magnet 235 to releasably secure hooks 240, it should be appreciated that the invention is not thus limited. As noted above, with regard to the embodiment of FIGS. 1 and 2, alternative retention mechanisms may also be used, for example, allowing hooks 240 to be snap-fit or press fit in place. In such cases, the securement branch 234 may extend beyond the outer surface of the lure body 210, such that hooks 240 may be physically coupled (e.g., snap-fit or press fit) to retention mechanisms provided thereon.

In alternative embodiments, the swivels 236 and hooks 240 may be provided within the lure body 210 itself. In such cases, the lure body 210 may be provided with a pair of hook slots to accommodate movement of the hooks 240 similar to those described above with respect to the embodiment of FIG. 1. The integrated hook harness 230 may also be provided with a limiting mechanism (not illustrated), which may act to limit the range of motion of the hooks 240. The integrated hook harness 230, for example, may include a sheath (e.g., a conical sheath or cowbell-shaped sheath) or similar feature around the swivels 236 to limit the hooks 240 ability to rotate, which may help to prevent damage to the lure body 210.

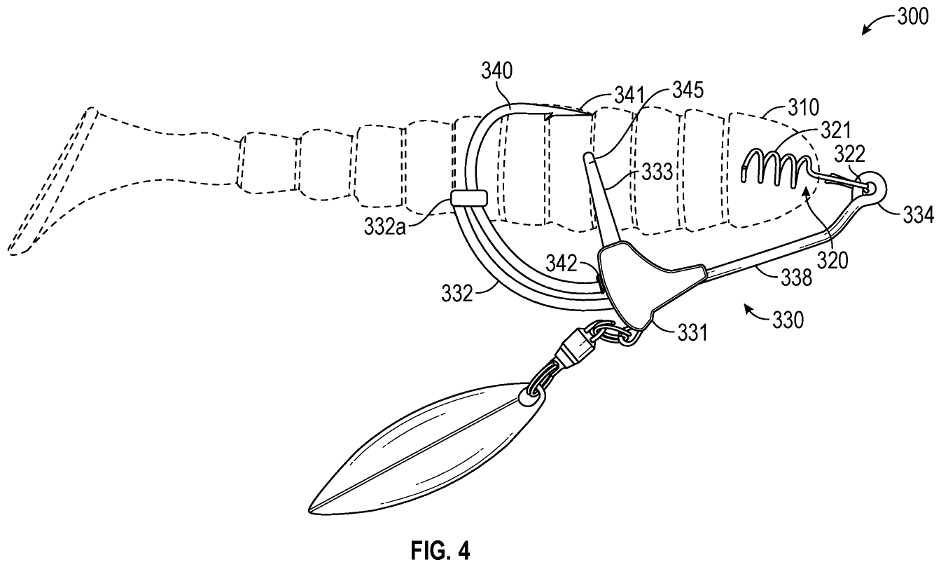

FIG. 4 depicts a third exemplary embodiment of a fishing lure 300 having an integrated hook harness external to the body of the fishing lure. As illustrated, the fishing lure 300 may include a lure body 310, a harness and line tie 320, a magnet hook harness 330, and hook 340. Fishing lure 300 may be a soft bodied lure, which as illustrated, may have a lure body 310 shaped to resemble a bait fish.

Harness and line tie 320 may act to secure the integrated hook harness 330 and may also be used to secure the fishing lure 300 to a fishing line. The harness and line tie 320, for example, may be formed of a corkscrew shaped tie body 321, which may be secured directly to the lure body 210, and a closed eye 322 to which the fishing line and integrated hook harness 330 may be attached.

The integrated hook harness 330 may act to orient and secure hook 340 within lure body 310, with the hook 340 being secured to the hook harness 330 in a manner that permits movement of the hook 340 relative to the integrated hook harness 330 and lure body 310. But in contrast to the embodiments of FIGS. 1 and 2, the integrated hook harness 330 may generally be external to the lure body 310.

As illustrated in FIG. 4, the integrated hook harness 330 may include a harness eye 334, a weighted portion 331, a hook securement portion 332, a magnet extension 333 and connecting arm 338. The harness eye 334 may be coupled to the eye 322 of the harness and line tie 320 and may serve to attach the integrated hook harness 330 to the fishing lure 300. The nature of the coupling may also allow the integrated hook harness 330 to rotate or pivot about the eye 322, which may facilitate the manual jigging of the fishing lure 300 by a user. The connecting arm 338 may extend from the eye 322 and terminate near the center of the lure body 310, and may act to position the hook securement portion 332 and magnet extension 333 as well as the weighted portion 331.

The weighted portion 331 may provide additional weight to the fishing lure 100, with the amount of weight provided by the weighted portion 331 depending on the sink rate and/or fishing depth desired for the fishing lure 100. The shape and position of the weighted portion 331 may allow the weight of the integrated hook harness 330 to be distributed in a particular manner so as to affect the swim and/or castability of the fishing lure 300.

The hook securement portion 332 may act to secure hook 340 while also permitting the hook 340 to move relative to the integrated hook harness 330 and lure body 310. As illustrated in FIG. 4, the hook securement portion 332 extends upward into (and terminates within) the lure body 310, and may be provided with a slide chamber 332a at its terminal end, which may slideably engage hook 340. The hook securement portion 332 and hook 340 may be arc like in shape, where the contour of the arc may dictate the path through which the hook 340 may slide.

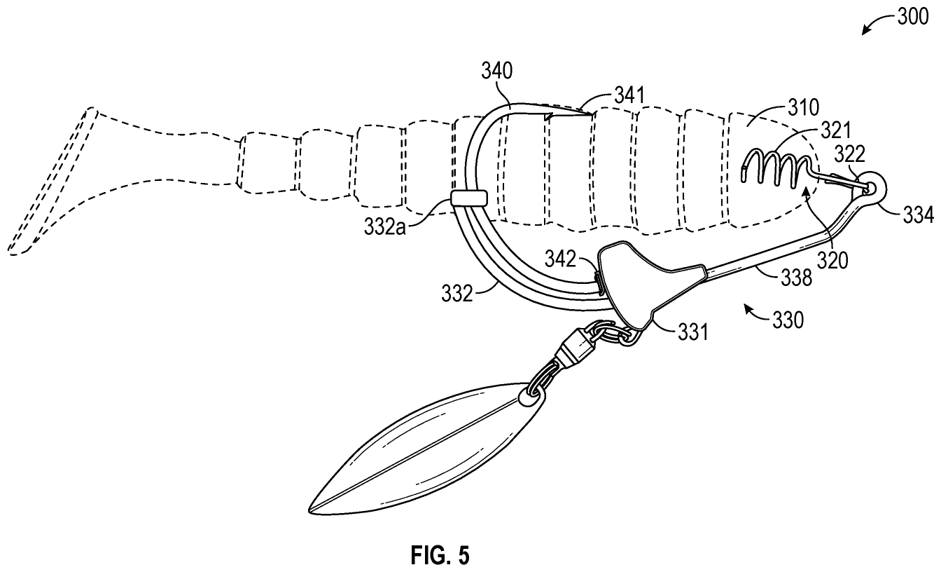

The magnet extension 333 may extend from the weighted portion 331 into (and terminate within) the lure body 310 and may be provided with a magnet 335 integrally formed at its terminal end. The hook point 341 of hook 340, when in a neutral, retracted position, may attach to the magnet 335, which may operate to keep hook 340 fixed in place. The hook 340 may be sized and shape such that the hook point 341 of hook 340 rests just below the surface of the lure body 310 when the hook 340 is secured in the neutral position. When a fish strikes at the lure, the hook 340 may be released and free to slide through slide chamber 332a, with the shape of the hook 340 and orientation of the slide chamber 332a dictating the path through with the hook 340 may travel. Depending on the shape of the hook 340 and slide chamber 332a (e.g., where the hook 340 is generally cylindrical in nature), the hook 340 may also be able to yaw about the slide chamber 332a. The hook 340 may also include a hook stopper 342 formed at the end of the hook 340 opposite hook point 341, which may act to limit the travel of the hook 340 through a terminal position. The lure body 310 may be provided with hook slots similar to those described above with respect to the embodiment of FIG. 1 to accommodate the movement of hooks 340. FIG. 5 depicts a fourth exemplary embodiment of a fishing lure 400 similar to that of FIG. 4 in most respects, but excludes magnet extension 333. Instead, the magnet 335 is integrally formed within weighted portion 331, and the hook stopper 342 of hook 340 attaches to magnet 335 to keep hook 340 fixed in its neutral position.

Furthermore, while the embodiments illustrated in FIGS. 4 and 5 may make use of a magnet 335 to releasably secure hook 340, it should be appreciated that the invention is not thus limited and that alternative retention mechanisms may be used. For example, as discussed above with regard to the embodiment of FIGS. 1 and 2, alternative retention mechanisms may be provided which may allow hook 340 to be snap-fit or press fit in place. By way of example, the weighted portion 331 or hook securement portion 332 of the integrated hook harness 330 may be provided with a cuff or sleeve into which the proximal end of hook 340 and/or hook stopper 342 could be snap-fit. As another example, hook 340 may be provided with one or more features (e.g., a bump, a ridge, or the like) which may snap fit with corresponding features in slide chamber 332a, with the position of the features along hook 340 being used to establish the neutral state of the hook 340. In yet other cases, hook 340 may be shaped in a particular way (e.g., having a larger diameter in a particular region), so as to press fit the hook 340 in place with slide chamber 332a, with the shape of the hook 340 (e.g., location of the larger diameter region) also establishing the neutral state of the hook 340.

While specific embodiments of the invention have been described above, it will be appreciated that the invention may be practiced other than as described. The description provided above is intended to be illustrative and non-limiting. Thus, it will be apparent to one skilled in the art that modifications may be made to the present invention as described without departing from the scope of the claims set out below. It is also worth noting that the Summary and Abstract sections may set forth one or more but not all exemplary embodiments of the present invention as contemplated by the inventor(s), and thus, are not intended to limit the present invention and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A fishing lure comprising:
a lure body;
a hook; and
an integrated hook harness comprising:
a securement mechanism to which the hook is movably secured; and
a retention mechanism configured to maintain the hook in a neutral state.

2. The fishing lure of claim 1 wherein the integrated hook harness is integrally formed within the lure body.

3. The fishing lure of claim 1, wherein the integrated hook harness is configured to maintain the hook entirely within the lure body when the hook is in the neutral state.

4. The fishing lure of claim 1, wherein the securement mechanism is configured to allow the hook to rotate.

5. The fishing lure of claim 4, wherein the integrated hook harness comprises a hook stopper to limit a rotation of the hook through a final state.

6. The fishing lure of claim 4, wherein the lure body comprises a hook slot through which the hook rotates.

7. The fishing lure of claim 1, wherein the hook is released by the retention mechanism upon application of a minimum actuation force.

8. The fishing lure of claim 1, wherein the integrated hook harness further comprises a weighted portion.

9. The fishing lure of claim 8, wherein the weighted portion is configured to distribute weight along the bottom of the lure body.

10. The fishing lure of claim 8, wherein the weighted portion is disposed toward a bottom of the lure body and shaped to conform to a profile of the lure body.

11. The fishing lure of claim 1 wherein the lure body is formed of soft plastic or rubber.

12. The fishing lure of claim 1 wherein the retention mechanism comprises a magnet.

13. The fishing lure of claim 1 wherein the retention mechanism is configured to snap-fit the hook in the neutral state.

14. A fishing lure comprising:
a lure body formed of a soft flexible material;
a hook; and
an integrated hook harness integrally formed within the flexible lure body, the integrated hook harness comprising:
a hook securement portion comprising:
a securement mechanism to which the hook is movably secured, whereby the hook is able to rotate about the securement mechanism and relative to the integrated hook harness and flexible lure body; and
a retention mechanism configured to maintain the hook in a neutral first state and release the hook upon application of an actuation force;
a weighted portion disposed toward a bottom of the lure body and shaped to conform to a profile of the lure body; and
a connecting arm joining the hook securement portion and weighted portion.

15. A fishing lure comprising:
a lure body formed of a soft flexible material;
a hook;
an integrated hook harness secured to a proximal end of the lure body and disposed substantially external to the flexible lure body, the integrated hook harness comprising:
a hook securement portion extending into the lure body and having a slide chamber provided at its terminal end, wherein the hook is slidably disposed within the slide chamber;
a retention mechanism configured to maintain the hook in a neutral first state and release the hook upon application of an actuation force; and
a weighted portion.

16. The fishing lure of claim 15 wherein the retention mechanism is a magnet.

17. The fishing lure of claim 16 wherein the magnet is integrally formed with the weighted portion.

18. The fishing lure of claim 16 wherein an arm is secured to the weighted portion at its proximal end and extends into the lure boy, and wherein the magnet is integrally formed at a distal end of the arm where it attracts a distal end of the hook to maintain the hook in the neutral first state.

19. The fishing lure of claim 15 wherein the hook comprises a hook stopper at its proximal end that limits movement of the hook through a final state, where the hook stopper engages with the slide chamber.

20. The fishing lure of claim 19 wherein the magnet attracts the hook stopper to maintain the hook in the neutral first state.
